(19) United States
(12) Patent Application Publication
(10) Pub. No.: US 2015/0190970 A1
(43) Pub. Date: Jul. 9, 2015

(54) TEXTURING OF 3D MEDICAL IMAGES

(71) Applicant: Michael Itagaki, Bellevue, WA (US)

(72) Inventor: Michael Itagaki, Bellevue, WA (US)

(21) Appl. No.: 14/580,982

(22) Filed: Dec. 23, 2014

Related U.S. Application Data
(60) Provisional application No. 61/923,425, filed on Jan. 3, 2014.

(51) Int. Cl. B29C 67/00; G05B 15/02; G06F 17/50

(52) U.S. Cl. CPC B29C 67/0088; G06F 17/50; G05B 15/02; B33Y 50/02

(57) ABSTRACT

A computing system having at least one processor is arranged to convert medical imaging data into a three-dimensional (3D) model of a medical object that has non-natural texturing (not naturally found in nature on the medical object). Medical imaging data is converted into a 3D surface representation, which may be exported into an engineering file format. The engineering file formatted data is then further converted into a 3D model of the medical object where color and/or surface texturing is applied to create 3D model of the medical object with non-natural texturing, and optionally other non-natural features. In one embodiment, the 3D model may then be printed using a 3D printing device to generate a physical representation of the medical object with non-natural texturing. The 3D model may also be rendered for use in generating one or more 3D images, such as a 3D animation sequence.

### CROSS-REFERENCE TO RELATED APPLICATIONS

This application claims the benefit under 35 U.S.C. §119(e) of U.S. Provisional Patent Application Ser. No. 61/923,425, filed Jan. 3, 2014, which is incorporated herein by reference.

### TECHNICAL FIELD

The present invention relates generally to digital imaging, and more particularly, but not exclusively, to using medical imaging data to create a three-dimensional physical object having non-natural texturing (texturing that is not natural to the object of the medical image).

### BACKGROUND

It seems that almost everywhere we turn we can see how computers have changed some aspect of our lives. Computing has even changed the realm of art. Today, computers have changed how movies are produced, music is created, as well as how artwork is created and/or displayed. Because computers provide the artist with a large variety of software applications, display devices, audio devices, and so forth, artists have a vastly improved opportunity to express themselves. However, as is clear to many, computers are still in their infancy, and there is a desire by end-users, such as artists, for more tools that enable them to more fully develop their artistic expressions. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the described embodiments, reference will be made to the following Detailed Description, which is to be read in association with the accompanying drawings, wherein:

FIG. 1 shows components of an illustrative system in which the described embodiments may be practiced;

FIG. 2 shows one embodiment of a computing device usable to create non-natural texturing on medical imaging data;

FIG. 3 illustrates one embodiment of a logical flow usable to generate a three-dimensional physical object having a non-natural texturing using medical imaging data;

FIG. 4 illustrates another embodiment of a logical flow usable to generate a three-dimensional physical object having a non-natural texturing using medical imaging data; and

FIGS. 5-10 illustrate non-exhaustive, non-limiting examples of possible physical objects having non-natural texturing that are created from medical imaging data.

### DETAILED DESCRIPTION

In the following detailed description of exemplary embodiments, reference is made to the accompanied drawings, which form a part hereof, and which show by way of illustration examples by which the described embodiments may be practiced. Sufficient detail is provided to enable those skilled in the art to practice the described embodiments, and it is to be understood that other embodiments may be utilized, and other changes may be made, without departing from the spirit or scope. Furthermore, references to “one embodiment” are not required to pertain to the same or singular embodiment, though they may. The following detailed description is, therefore, not to be taken in a limiting sense, and the scope of the described embodiments is defined only by the appended claims.

Throughout the specification and claims, the following terms take the meanings explicitly associated herein, unless the context clearly dictates otherwise. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “non-natural,” as in “non-natural texturing,” refers to a surface texture of an object, such as an object from a medical image, where the surface texture is not naturally occurring to the object for which the medical image represents. Thus, for example, while texturing that represents a rock surface, hair, grass, a vegetable, and so forth, occur in nature, when these non-limiting example textures are on a human organ, bone, or other object obtained from a medical image, these textures become non-natural or non-natural texturing to the object.

As used herein “medical imaging data format” refers to any of a variety of healthcare data formats used to capture and/or store medical images. One such non-limiting, non-exhaustive, healthcare data format is known as Digital Imaging and Communications in Medicine (DICOM), which is a standard for handling, storing, printing, and transmitting information in medical imaging. However, “medical imaging data formats” may include other formats, including those developed by Health Level Seven (HL7), which is an organization involved in the development of international healthcare informatics interoperability standards; Integrating the Healthcare Enterprise (IHE) related standards; as well as others.

The following briefly provides a simplified summary of the subject innovations in order to provide a basic understanding of some aspects. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, subject innovations are directed toward computer systems, methods, non-transitory storage devices, computer devices, and so forth, that are arranged to convert medical imaging data into a three-dimensional (3D) image object having non-natural texturing. Medical imaging data may be received from a variety of sources, including, but not limited to, for example, a medical imaging device, such as a computed tomography (CT) device, a Magnetic Resonance Imaging (MRI) device, Ultrasound device, or any other device that may be configured to obtain an image of an organism or component thereof. It should be noted that such images may be viewable directly from the imaging data, or may require manipulation of the imaging data prior to being able to be viewed on a display device or other viewing device. In some embodiments, the medical imaging data may be in a two-dimensional (2D) representation. Moreover, in some embodiments, the medical imaging data may include a plurality of images, such as a series of images.

The medical imaging data may then be converted from 2D images to a 3D surface representation of the object for which the medical imaging data represents. This 3D surface data set representing a medical model of the object may then be exported (or otherwise converted) into an engineering file format useable by a 3D software application. Surface texturing data and/or coloring data may then be applied to the 3D medical model to generate a non-natural surface texturing of the 3D medical model. In some embodiments, the 3D medical model may be further modified by adding non-natural features in addition to the surface texturing. The modified 3D medical model, having at least non-natural surface texturing, may then be printed using a 3D printing technology to generate a 3D physical object. However, the invention is not constrained to 3D printing of the modified 3D medical model. For example, in other embodiments, a 3D rendering of the modified 3D medical model also may be used to generate a 3D image or 3D animation, such as in a series of 3D images. In this embodiment, the rendering may be used in 3D animation providing, for example, more anatomically realistic and detailed objects than might be designed traditionally.

It should be noted that while the embodiments described herein refer to 3D medical models with non-natural surface texturing, the invention is not limited to merely 3D medical models with non-natural surface texturing. For example, a series of images may be generated that may be employed within a movie, or other video stream. Further, the 3D medical model with non-natural surface texturing might be configured to be displayed using holographic technology, or other visual forms. Further, while the 3D medical model with non-natural surface texturing may be useable within an artistic context, the generated output may also be used for educational purposes, as well as other purposes, and as such should not be construed as being constrained to a particular application.

### Illustrative Operating Environment

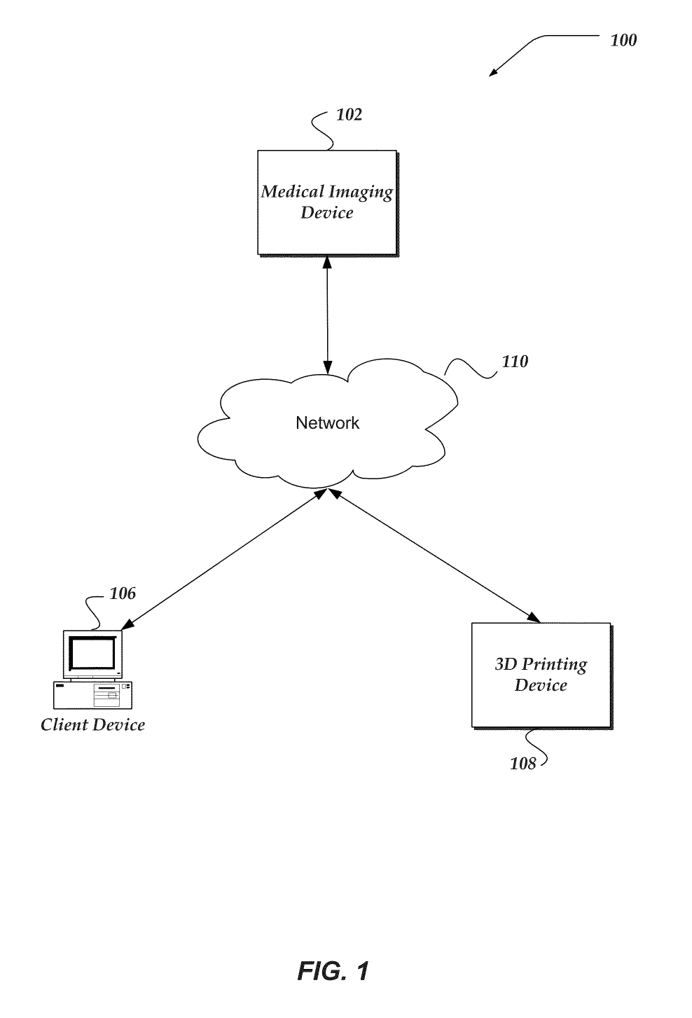

FIG. 1 shows components of an illustrative system 100 in which the described embodiments may be practiced. Not all the components may be required to practice the described embodiments, and variations in the arrangement and type of the components may be made without departing from the spirit or scope of the described embodiments. FIG. 1 shows that system 100 as including medical imaging device 102, client device 106, network 110, and 3D printing device 108.

Medical imaging device 102 includes virtually any device capable of capturing image data of an organism, such as a human body (or parts and/or functions thereof), typically for clinical purposes and/or medical science. Non-exhaustive, non-limiting examples of such devices include computer tomography (CT) devices, Magnetic Resonance Imaging (MRI) devices, Ultrasound devices, and so forth. Typically, such devices may scan the organism, or component thereof, to capture two-dimensional medical imaging data. Such medical imaging data may be in any of variety of data formats, including, but not limited to DICOM, HL7, IHE, or so forth. In some embodiments, medical imaging device 102 may include a computing device, a non-transitory computer-readable storage device, or the like, configured to receive and store the medical imaging data. The medical imaging data may include a set of data representing a single image or a plurality of images. In one embodiment, the medical imaging data set may be provided over a network, such as network 110, to another device, such as client device 106, a remote non-transitory storage device, or other remote device.

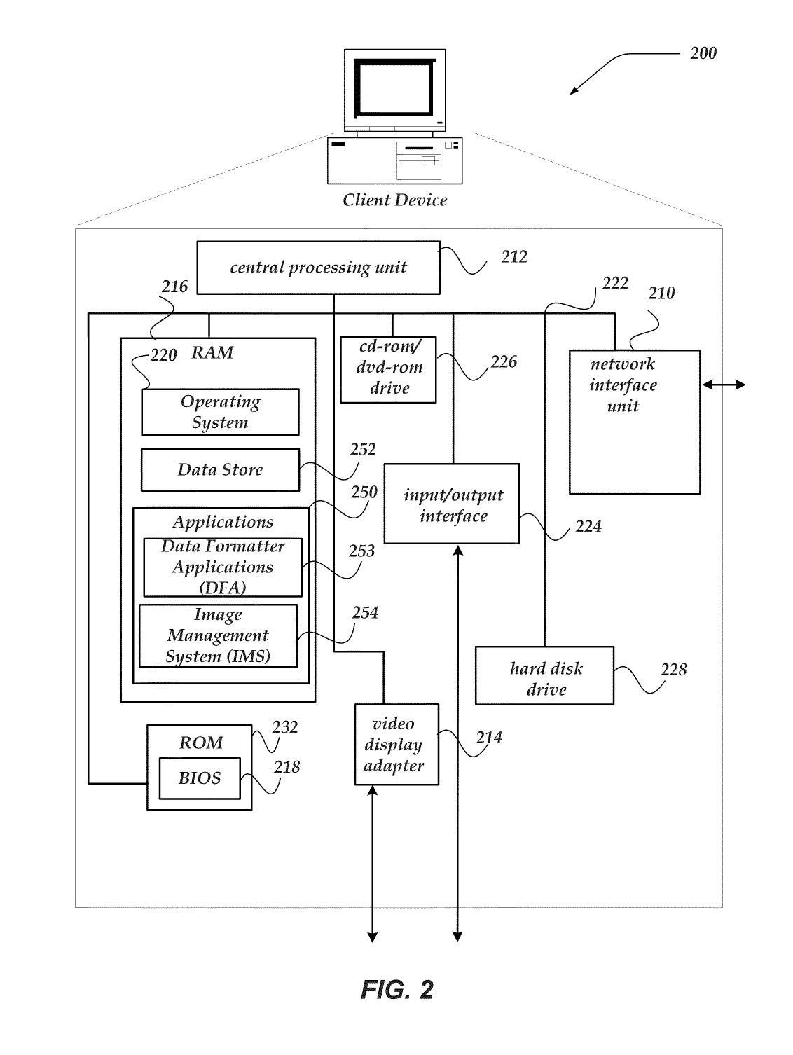

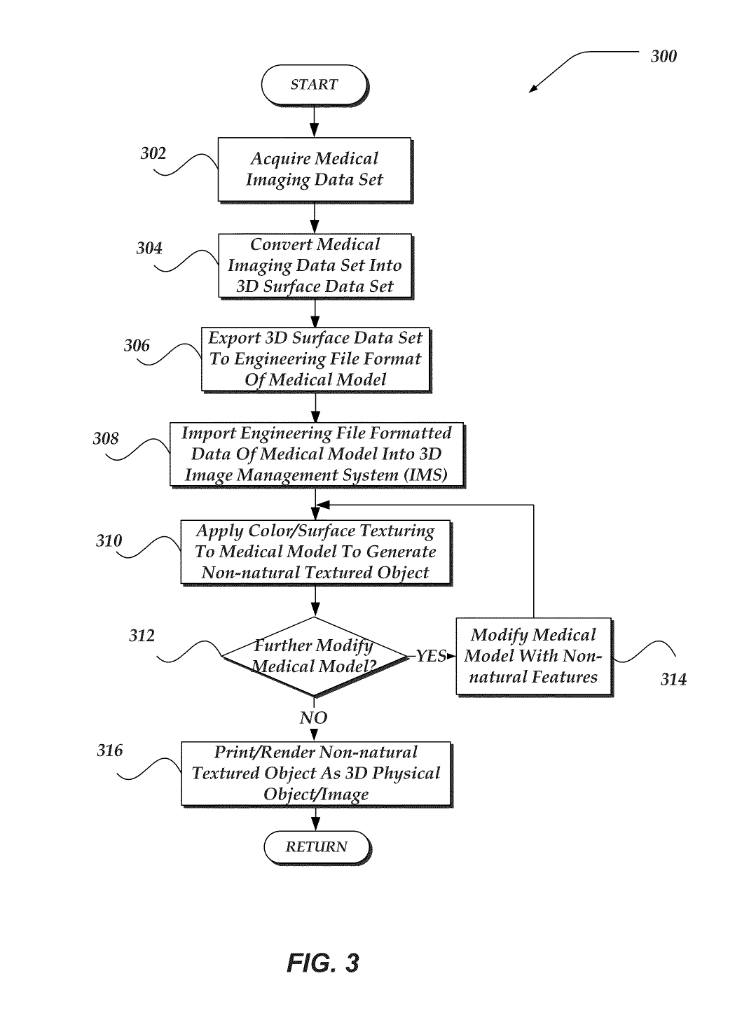

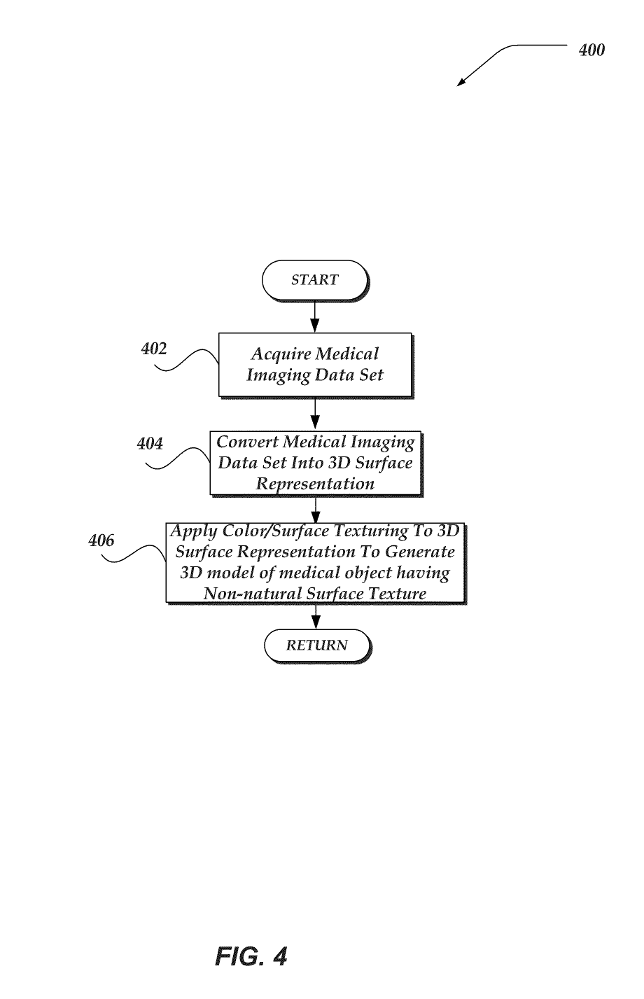

One embodiment of client device 106 is described in more detail below in conjunction with FIG. 2. Briefly however, client device 106 may include virtually any computing device having one or more processors and capable of connecting to another computing device, receiving information, and executing computer instructions to perform actions, such as described in more detail below in conjunction with FIGS. 3-4. Such devices may include personal computers, multiprocessor systems, microprocessor-based or programmable consumer electronics, network devices, and the like. Client device 106 may also include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Client device 106 may also include virtual computing devices running in a hypervisor or some other virtualization environment. As such, client device 106 may range widely in terms of capabilities and features.

A web-enabled client device may include a web browser application that is configured to receive and to send web pages, web-based messages, and the like. The web browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HTML, eXtensible Markup Language (XML), Compact HTML (cHTML), EXtensible HTML (xHTML), or the like, to display and send a message.

Client device 106 also may include at least one other client application that is configured to receive content from another computing device. The client application may include a capability to provide and receive textual content, graphical content, audio content, and the like. The client application may further provide information that identifies itself, including a type, capability, name, and the like.

Client device 106 may receive data from one computing device in a first data format, and employ one or more computing applications that convert the data from the first data format to one or more other data formats. In some embodiments, the received data may represent a medical model of an organism, or component thereof. For example, the data may represent a heart, lung, one or more bones or components of a bone, tissue, or the like, from a human or other organism.

Client device 106 may include a variety of other applications that are configured to employ the one or more other data formats to generate a 3D representation of the medical model having non-natural surface texturing, and optionally one or more other non-natural features. Client device 106 may further employ 3D printing device 108, or other object generator device, to generate a physical embodiment of the 3D representation of the medical model having at least non-natural surface texturing. As noted elsewhere, while 3D printing device 108 represents a printer that is configured to generate a physical representation of the medical model, device 108 might instead (or in addition) be configured to generate a holographic representation, or other type of physical representation that is external to client device 106.

As further shown in FIG. 1, network 110 is configured to couple network enabled devices, such as client device 106, medical imaging device 102, and 3D printing device 108, with other network enabled devices. Network 110 is enabled to employ any form of computer readable media for communicating information from one electronic device to another. In one embodiment, network 108 may include the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs to enable messages to be sent from one to another. Also, communication links within LANs typically include fiber optics, twisted wire pair, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. It should be noted that such communication links should not be construed as representing computer-readable storage devices as the term is used herein.

Network 110 may further employ a plurality of wireless access technologies including, but not limited to, 2nd (2G), 3rd (3G), 4th (4G) generation radio access for cellular systems, Wireless-LAN, Wireless Router (WR) mesh, and the like. Access technologies such as 2G, 3G, 4G, and future access networks may enable wide area coverage for network devices, such as client device 106, or the like, with various degrees of mobility. For example, network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link, a DSL modem, a cable modem, a fiber optic modem, an 802.11 (Wi-Fi) receiver, and the like. In essence, network 110 includes any communication method by which information may travel between one network device and another network device.

3D printing device 108 includes any special purpose printing device that is configured to receive digital model data and to generate a three-dimensional physical (solid) object of virtually any shape. In some embodiments, the physical object may be created using an additive process where successive layers of material are laid down in different shapes. Such technique may be considered distinct from other printing techniques which may rely on removal of material by methods such as cutting or drilling—a subtractive process. Non-limiting, non-exhaustive examples of 3D printing devices include printers from 3D Biotic, 3D Kits, 3D Stuffmaker, Active 3D, Makergear, Zbot, Zortax, and Zcorp, to name just a few.

It should be noted that in some embodiments, 3D printing device 108 may instead be configured to generate other 3D objects from the 3D model data, including, but not limited to holographic generations.

### Illustrative Computing Device

FIG. 2 shows one embodiment of a client device, according to one embodiment of the invention. Client device 200 may include many more or less components than those shown. The components shown, however, are sufficient to disclose an illustrative embodiment for practicing the invention. Client device 200 may represent, for example, client device 106 of FIG. 1.

Client device 200 includes central processing unit (CPU) 212, video display adapter 214, and a mass memory, all in communication with each other via bus 222. The mass memory generally includes RAM 216, ROM 232, and one or more permanent (non-transitory) mass storage devices, such as hard disk drive 228, tape drive, optical drive, and/or floppy disk drive. The mass memory stores operating system 220 for controlling the operation of client device 200. While FIG. 2 illustrates a single box for CPU 212, it should be understood that client device 200 may actually include one or more central processing units (a plurality of processors) that are configured to execute computer-executable instructions to cause client device 200 to perform actions. Client device 200 therefore also includes applications 250, which includes Data Formatter Applications (DFA) 253 and Image Management System (IMS) 254.

As illustrated in FIG. 2, client device 200 also can communicate with the Internet, or some other communications network via network interface unit 210, which is constructed for use with various communication protocols including the TCP/IP protocol. Network interface unit 210 is sometimes known as a transceiver, transceiving device, or network interface controller (NIC) card.

The mass memory as described herein illustrates another type of non-transitory computer readable media, namely computer storage devices. Computer storage devices may include volatile, nonvolatile, removable, and non-removable devices implemented in any method or technology for non-transitory storage of information, such as computer readable instructions, data structures, program modules, or other data. Examples of computer storage devices include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical non-transitory medium which can be used to store the desired information and which can be accessed by a computing device.

The mass memory also stores program code and data. One or more applications 250 are loaded into mass memory and run on operating system 220. Examples of application programs may include email programs, routing programs, schedulers, calendars, database programs, word processing programs, HTTP programs, traffic management programs, security programs, and so forth. Applications 250 also include DFA 253 and IMS 254.

DFA 253 includes one or more computer programs configured to execute within CPU 212 to receive data in a first data format and to convert the data into one or more other data formats. For example, DFA 253 may receive data, such as medical imaging data in a medical imaging data format, such as DICOM, HL7, IHE, or the like, and to convert the series of 2D medical imaging data into a 3D surface data set. In one embodiment, the data may also be received already in a 3D surface data set format. For example, an application, such as DFA 253 or the like, may reside within or with medical imaging device 102 of FIG. 1, such that the conversion occurs prior to being received by client device 200. In another embodiment, the data may be received by DFA 253 in the medical imaging data format and converted on client device 200. A non-limiting example of an application configured to perform such conversion includes OsiriX. However, other programs may also be employed.

DFA 253 may also be configured to receive the 3D surface data set and export or otherwise convert the 3D surface data set representing a medical model of the object into an engineering file format (EFF) usable by various Computer-Aided Design (CAD) application packages. One such non-limiting format includes the STereoLithography (STL) file format. However, other formats may also be used, including, Additive Manufacturing File Format (AMF), Polygon File Format (PLY), Stanford Triangle Format, Wavefront .obj file format, COLLADA from Collaborative Design Activity, or the like.

DFA 253 may export or otherwise store its various output into data store 252, or on other non-transitory storage devices, including cd-rom/dvd-rom drive 226, hard disk drive 228, or other storage devices. In some embodiments, DFA 253 may also store its output remote from client device 200. In some embodiments, DFA 253 may be configured to directly provide its output to IMS 254.

IMS 254 is configured to receive the engineering file formatted data set representing the medical model of the object and to apply color and surface texturing onto the medical model to create a non-natural textured medical model. In one embodiment, IMS 254 may receive various data sets for different textures that may be applied to the medical model. For example, in one embodiment, IMS 254 might receive photographic image data that includes one or more textures useable in performing the non-natural texturing. In one embodiment, the texture data might be stored in data store 252; however, other locations may also be used to store the texture data.

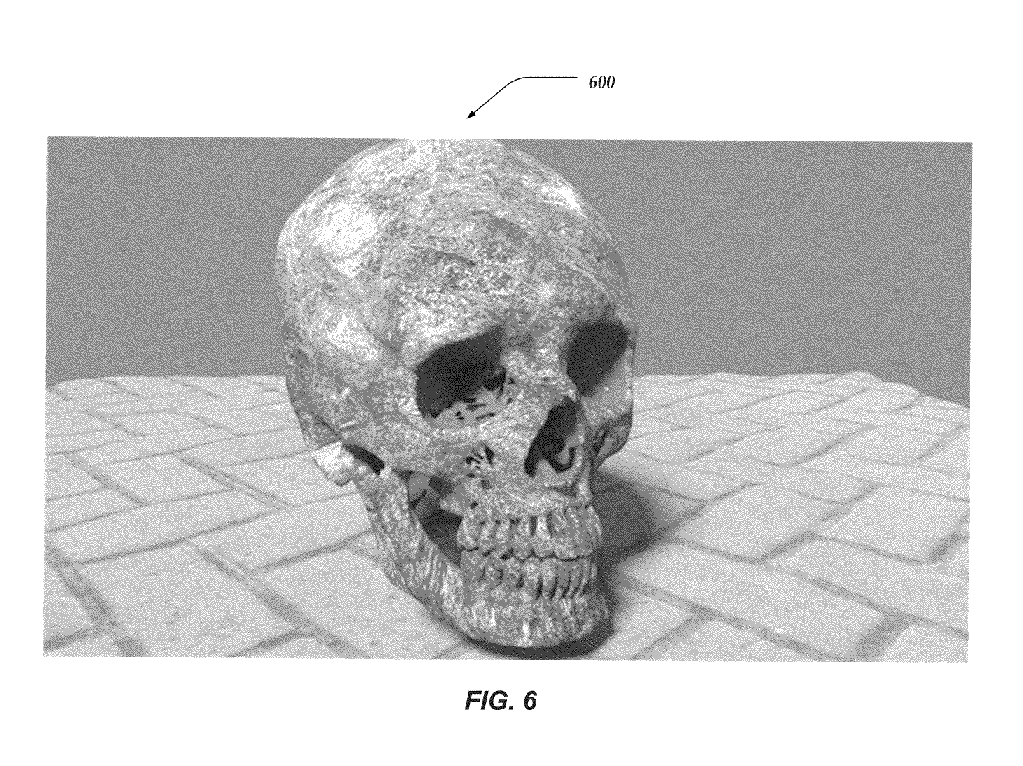

IMS 254 may be employed to display through a display device various results of the non-texturing and/or coloring process. IMS 254 may also be used to modify the 3D model data with one or more other non-natural features. Non-limiting, non-exhaustive examples of 3D models with non-natural features in addition to non-natural texturing are illustrated in FIGS. 6-8. For example, shown in FIG. 6, is a 3D model 600 of skull 601 is shown, having non-natural texturing and coloring from a pumpkin, and having further, a non-natural feature of a pumpkin stem/cap 602. The stem portion of stem/cap 602 is shown having a texture/coloring obtained from a cucumber. The stem/cap 602 is illustrated separated from skull 601 to show a removal feature of the stem/cap 602. This unique combination has artistic value since a jack-o-lantern is a pumpkin that is carved to look like a skull, whereas 3D model 600 is a skull that is ironically colored to look like a pumpkin. FIG. 6 also provides one non-limiting embodiment of a 3D rendering.

In one embodiment, IMS 254 may be used to provide the 3D non-natural textured model data to 3D printing device, or other output generation device. In any event, DFA 253 and/or IMS 254 may employ one or more components of the process 300 of FIG. 3 and/or process 400 of FIG. 4 described below to perform at least some of their actions.

Client device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion. Moreover, client device 200 may further include applications that support virtually any secure connection, including TLS, TTLS, EAP, SSL, IPSec, and the like.

Client device 200 may also include input/output interface 224 for communicating with external devices, such as a mouse, keyboard, scanner, or other input devices not shown in FIG. 2. Likewise, client device 200 may further include additional mass storage facilities such as CD-ROM/DVD-ROM drive 226 and hard disk drive 228. Hard disk drive 228 may be utilized to store, among other things, application programs, databases, and the like.

### Generalized Operation

The operation of certain aspects will now be described with respect to FIG. 3. FIG. 3 illustrates one embodiment of a logical flow usable to generate a three-dimensional physical object having a non-natural texturing using medical imaging data. Process 300 of FIG. 3 may be implemented within client device 106 of FIG. 1, and as described further in conjunction with FIG. 2.

Process 300 of FIG. 3 begins, after a start block, at block 302 where a medical imaging data set is acquired. In one embodiment, the medical imaging data set is digital data that is acquired from a medical scanning device, such as a CT, MRI, Ultrasound, or other medical imaging device. However, the medical imaging data set may also be received from a storage device having been scanned using a medical imaging device at some prior time period.

In some embodiments, the medical imaging data set represents 2D images acquired using any of a variety of healthcare imaging data formats, including, for example, DICOM, HL7, IHE, or so forth. With a series of such data images, a 3D data set can be created.

Processing flows next to block 304, where the series of 2D medical images is converted to a 3D surface representation. While this feature may be available in some medical imaging devices, in some embodiments, such conversion may be performed within a client device, such as client device 106 of FIG. 1. Such conversion may further enable viewing/display on a computing display device, the medical images. While any of a variety of applications may be used to perform such conversion of the medical imaging data set to a surface representation, one non-limiting, non-exhaustive example of a useable application includes OsiriX Imaging Software.

Continuing to block 306, the generated 3D surface data set may then be exported (or otherwise converted) to an Engineering File Format (EFF). One example of such EFF includes STL, which is a format typically used for engineering CAD software. However, other EFFs may also be used, including but not limited to the non-limiting examples noted above. Converting a medical imaging data set is performed to enable importing of the data into various 3D software applications, such as CAD applications, and so forth.

Process 300 flows next to block 308, where the STL file, or other equivalent 3D image files (there are several other possible types), is then imported into a software package, such as IMS 254 of FIG. 2, or the like. One example of such software package includes, but is not limited to an application obtained from Blender.org, that enables generation of 3D animation, photorealistic rendering, and video design. While this example application may not be designed to visualize or process medical scan data, using STL file format enables importing of the medical model data into the application to perform unique actions upon the data.

Continuing next to block 310, non-natural surface texturing may be applied to the imported digital medical model to generate a non-natural textured 3D object. In one embodiment, the texturing may be obtained from a photograph having the texture. However, the texturing may be created and/or otherwise obtained from any of a variety of mechanisms, including but not limited to creating the texturing using a variety of drawing tools. During block 310, a plurality of different non-natural surface textures might be applied.

In one embodiment a UV map may be created, where the letters “U” and “V” denote axes of a 2D model of a flattened representation of the surface of the 2D object. This UV map may then be superimposed onto a digital photograph, which is also flat. The color and/or surface texture of the photograph is then transposed onto the corresponding surfaces of the UV map, and subsequently onto the 3D surface medical model.

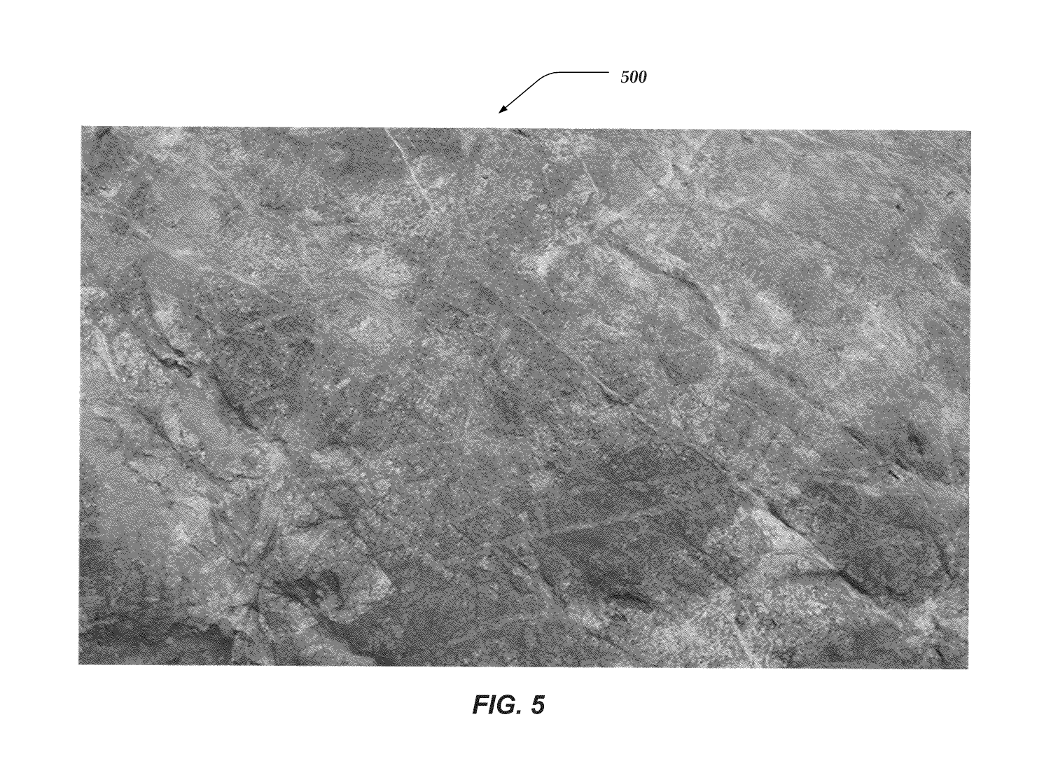

As an aside, FIG. 5 illustrates a non-limiting, non-exhaustive example of an image of surface texturing. In this example, texture 500 illustrates texturing of a boulder or rock substrate. FIG. 6 illustrates skull 600 having texture 500 of FIG. 5, UV mapped to give an appearance of a skull created from rock.

However, it should be understood that the invention is not constrained to a particular surface map, and others may also be used. For example, a color mapping may be performed where, for example, color data from a photograph or other source, may be transposed onto the 3D surface medical model. This might be achieved, for example, via a UV mapping function, such as discussed above.

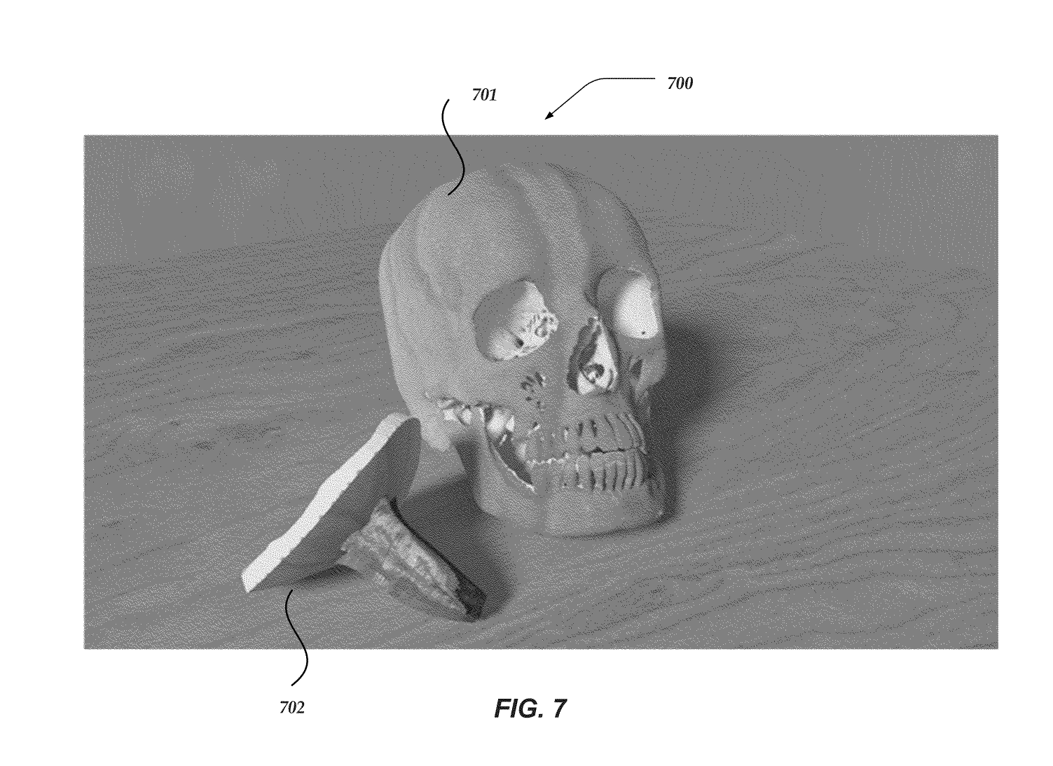

Coloring may be applied that may also be non-natural to the medical model. For example, a medical model of a skull might be colored red, orange, green, pinstriped, or other non-bone, non-natural color. By performing various actions, an anatomically accurate skeleton for example, might enable the creation of a cartoon character that appears more lifelike, thereby providing a novel and unique approach to animation modeling. However, as shown in FIG. 7, for example, a variety of other potential artistic renderings also may be created.

In still other embodiments, bump mapping, normal mapping, and/or displacement mapping, may be used to create maps from a photograph (or other source), which is then mapped to the 3D surface medical model using a UV map approach. These non-limiting example approaches may be used to generate deformations of the surface contour to give an even more realistic appearance when selectively 3D rendering and/or 3D printing of the results. As one non-limiting example, grooves in a surface of weathered wood due to uneven wear on growth rings might be applied to the 3D surface medical model.

A specularity map may be generated, in other embodiments, from a photograph or other source, which may then be used to show varying reflectivity of a surface. For example, in a 3D rendering of a cobblestone street, specularity mapping may be used to make portions of the raised parts of the stones shinier. This approach may then be applied to the 3D surface medical model.

Parallax occlusion mapping may also be used as another type of mapping to provide more realism in applying non-natural surface textures to the 3D surface medical model. Thus, it should be understood that the invention disclosed herein is not constrained to a particular approach of applying non-natural surface textures, and virtually any approach may be used.

Returning to FIG. 3, process 300 flows next to decision block 312 where a determination is made whether to modify the medical model further, perhaps by adding other non-natural features. If so, then processing flows to block 314; otherwise, processing flows to block 316.

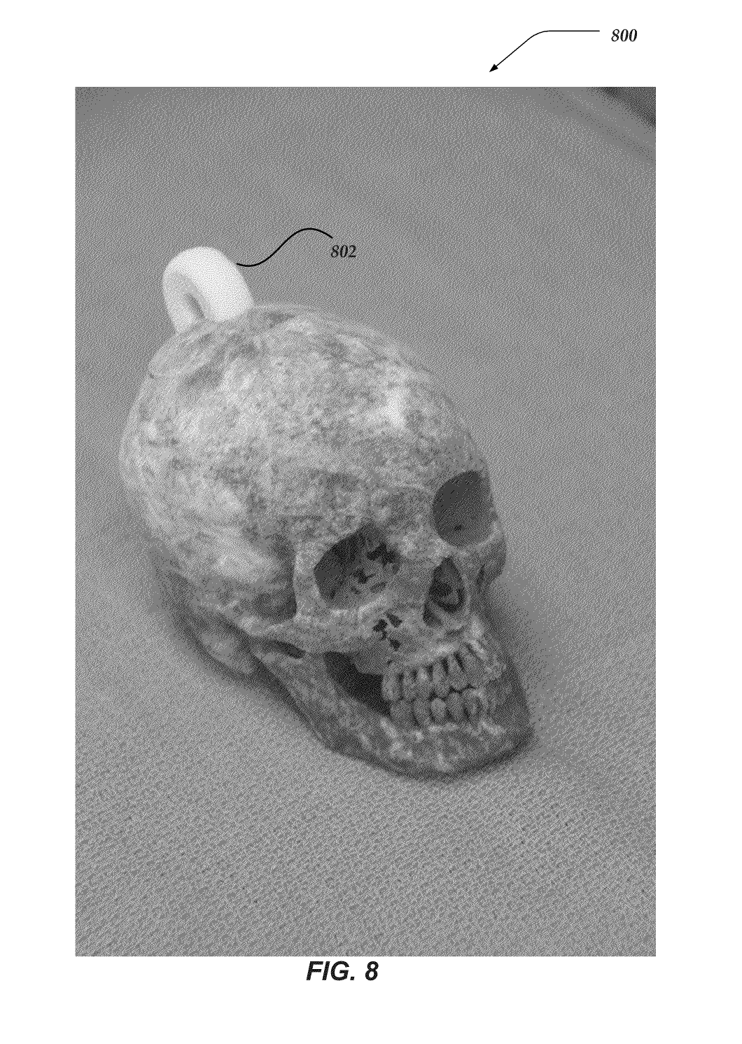

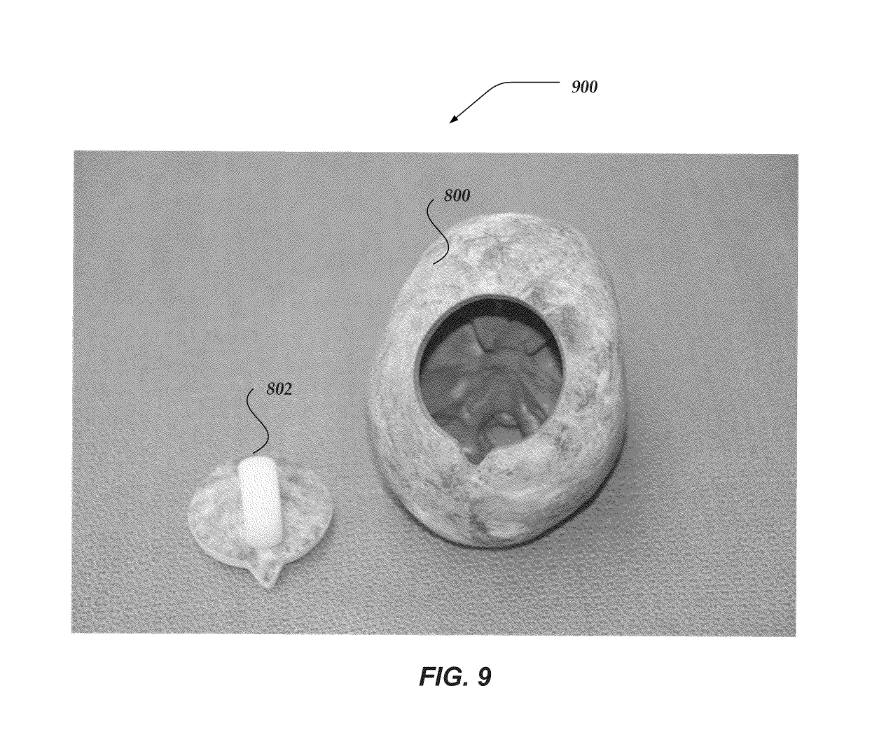

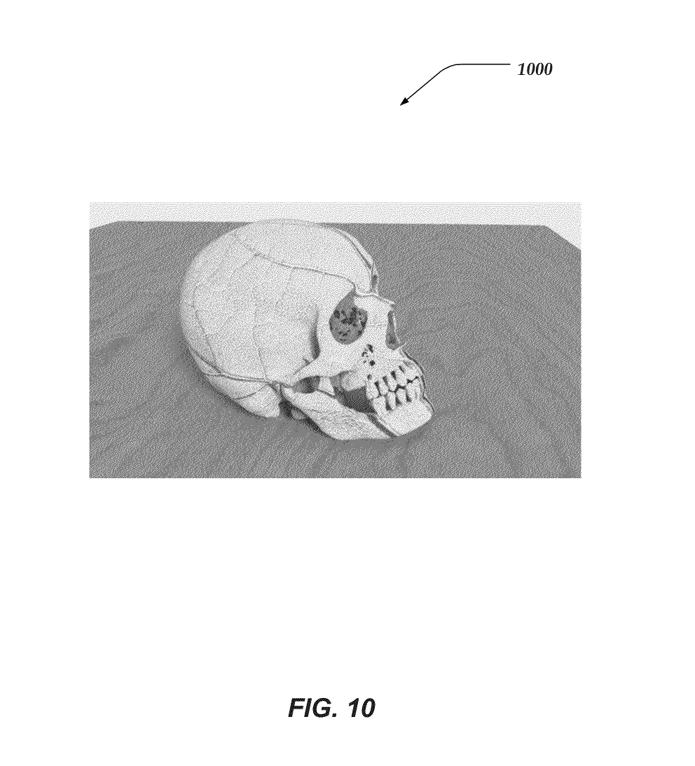

At block 314, the medical model is further modified with additional non-natural features. For example, as discussed above in conjunction with FIG. 7, a pumpkin with a detachable lid might be created. In FIG. 8 is shown a skull 800 with a non-natural texture from a boulder to give an appearance of a rock. Skull 800 also includes detachable lid 802 with a small handle, thus turning skull 800 into, for example, a small apothecary jar. FIG. 9 shows another perspective 900 of the skull 800 with detachable lid 802 of FIG. 8. FIG. 10 illustrates yet another skull 1000 having non-natural texturing and a lime green coloring.

Process 300 then branches back to block 310 to allow for further texting, coloring, and/or (by flowing back through block 314) non-natural feature additions, until the decision at decision block 312 is to flow to block 316.

At block 316, the non-natural textured medical object may be printed as a 3D physical object using a 3D printing device. It should be noted that the modified medical object having non-natural texturing need not be physically printed. In some embodiments, other techniques might be used to display the modified object, including but not limited to photographs, videos, and/or holographic displays of the modified object. Thus, at block 316, various 3D rendering may be applied to the modified medical object having non-natural texturing to, for example, generate one or more 3D images, such as might be used to generate a 3D video sequence, stream, or the like.

Thus, the non-natural textured medical model may be provided in a variety of techniques. Upon completion of block 316, process 300 may then return to a calling process.

FIG. 4 illustrates another embodiment of a logical flow usable to generate a three-dimensional physical object having a non-natural texturing using medical imaging data. Process 400 of FIG. 4 may be implemented within client device 106 of FIG. 1, and as described further in conjunction with FIG. 2.

Process 400 of FIG. 4 begins, after a start block, at block 402 where a medical imaging data set is acquired. Blocks 402 and 404 are substantially similar to blocks 302 and 304 of FIG. 3, and results in generation of a 3D surface data set that represents the medical model in the medical imaging data set. Moving to block 406 color and/or surface texturing is performed on the 3D surface representation of the medical model to generate a 3D model of the medical object having a non-natural surface texture. Block 406 may employ actions such as those disclosed above in conjunction with block 306 of FIG. 3 to generate the 3D model with non-natural texturing. Upon completion of block 406, process 400 may return to a calling process.

It will be understood that figures, and combinations of steps in the flowchart-like illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions execute on the processor to provide steps for implementing the actions specified in the flowchart block or blocks. These program instructions may be stored on a computer readable medium or machine readable medium, such as a computer readable storage medium.

Accordingly, the illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by modules such as special purpose hardware-based systems which perform the specified actions or steps, or combinations of special purpose hardware and computer instructions.

The above specification, examples, and data provide a complete description of the manufacture and use of the composition of the described embodiments. Since many embodiments can be made without departing from the spirit and scope of this description, the embodiments reside in the claims hereinafter appended.

What is claimed as new and desired to be protected by Letters Patent of the United States is:

1. A computing system, comprising:
a non-transitory storage device configured to store medical imaging data of a medical object acquired from a medical imaging device, the medical imaging data being in a medical imaging data format;
one or more computing devices having at least one processor configured to perform actions comprising:
converting the medical imaging data into a three-dimensional (3D) surface representation of the medical object; and
generating a 3D model of the medical object having a non-natural surface texture using the 3D surface representation of the medical object.

2. The computing system of claim 1, further comprising:
a three-dimensional (3D) printing device that is arranged to perform actions, including:
receiving digital data for the 3D model of the medical object having the non-natural surface texture; and
generating a 3D printed physical representation of the non-natural surface textured medical object using the received digital data for the 3D model.

3. The computing system of claim 1, comprising a holographic device that receives the digital data for the 3D model of the medical object having the non-natural surface texture and displaying a 3D holographic representation of the object having the non-natural surface texture.

4. The computing system of claim 1, wherein one or more computing devices having at least one processor configured to perform further actions comprising:
modifying the 3D model of the medical object having a non-natural surface texture to include at least one other non-natural feature to the medical object.

5. The computing system of claim 4, wherein the at least one other non-natural feature includes modifying the 3D model to include a detachable component.

6. The computing system of claim 1, wherein generating the 3D model of the medical object having the non-natural surface texture further includes modifying a color of the 3D model to a non-natural color for the medical object.

7. The computing system of claim 1, wherein generating the 3D model of the medical object having the non-natural surface texture further includes employing a UV mapping of the 3D medical object that is superimposed onto a digital photograph of the non-natural texture.

8. A processor based method, the method comprising:
receiving medical imaging data of a medical object acquired from a medical imaging device, the medical imaging data being in a medical imaging data format;
converting the medical imaging data into a three-dimensional (3D) surface representation of the medical object; and
generating a 3D model of the medical object having a non-natural surface texture using the 3D surface representation of the medical object.

9. The processor based method of claim 8, wherein generating the 3D model of the medical object having the non-natural surface texture further includes employing a UV mapping of the 3D medical object that is superimposed onto a digital photograph of the non-natural texture.

10. The processor based method of claim 8, wherein generating the 3D model of the medical object having the non-natural surface texture further includes modifying a color of the 3D model to a non-natural color for the medical object.

11. The processor based method of claim 8, the method further comprising:
modifying the 3D model of the medical object having a non-natural surface texture to include at least one other non-natural feature to the medical object

12. The processor based method of claim 8, the method further comprising:
displaying a 3D holographic representation of the 3D model of the medical object having the non-natural surface texture.

13. The processor based method of claim 8, the method further comprising:
rendering the 3D model of the medical object having a non-natural surface texture to generate one or more 3D images.

14. The processor based method of claim 8, the method further comprising:
employing a 3D printing device to generate a 3D printed physical representation of the non-natural surface textured medical object using the received digital data for the 3D model.

15. A non-transitory storage device having stored thereon a plurality of computer-executable instructions that when installed on a computing device having a processor performs actions, comprising:
receiving medical imaging data of a medical object acquired from a medical imaging device, the medical imaging data being in a medical imaging data format;
converting the medical imaging data into a three-dimensional (3D) surface representation of the medical object; and
generating a 3D model of the medical object having a non-natural surface texture using the 3D surface representation of the medical object.

16. The non-transitory storage device of claim 15, wherein the processor performs actions, further including:
providing the digital data for the 3D model of the medical object having the non-natural surface texture to a 3D printing device configured to generate a 3D physical representation of the non-natural surface textured medical object.

17. The non-transitory storage device of claim 15, wherein the processor performs actions, further including:
providing the digital data for the 3D model of the medical object having the non-natural surface texture to a holographic device configured to generate a 3D holographic representation of the non-natural surface textured medical object.

18. The non-transitory storage device of claim 15, wherein the processor performs actions, further including modifying the 3D model of the medical object having a non-natural surface texture to include at least one other non-natural feature to the medical object.

19. The non-transitory storage device of claim 15, wherein the processor performs actions, further including modifying the 3D model of the medical object having a non-natural surface texture to include a detachable component.

20. The non-transitory storage device of claim 15, wherein generating the 3D model of the medical object having the non-natural surface texture further includes modifying a color of the 3D model to a non-natural color for the medical object.

21. The non-transitory storage device of claim 15, wherein generating the 3D model of the medical object having the non-natural surface texture further includes employing a UV mapping of the 3D medical object that is superimposed onto a digital photograph of the non-natural texture.

22. The non-transitory storage device of claim 15, wherein the processor performs actions, further including:
rendering the digital data for the 3D model of the medical object having the non-natural surface texture to generate one or more 3D images.
